(19) United States
(12) Patent Application Publication
(10) Pub. No.: US 2007/0172058 A1
(43) Pub. Date: Jul. 26, 2007

(54) Data transmitting apparatus and data receiving apparatus

(76) Inventors: Tomokazu Sada, Osaka (JP); Masaru Fuse, Osaka (JP); Satoshi Furusawa, Osaka (JP); Tsuyoshi Ikushima, Nara (JP)

Correspondence Address: WENDEROTH, LIND & PONACK L.L.P., 2033 K. STREET, NW, SUITE 800, WASHINGTON, DC, 20006, US

(21) Appl. No.: 11/656,969

(22) Filed: Jan. 24, 2007

(30) Foreign Application Priority Data
Jan. 25, 2006 (JP) 2006-016305

(51) Int. Cl. H04N 7/167

(52) U.S. Cl. 380/212

(57) ABSTRACT

A data communication apparatus 1 for safely transmitting information data 11 and additional information 14 is provided. In a data transmitting apparatus 101, a random number sequence generating part 111 generates a random number sequence 12 from key information 11. A diffusing part 112 generates diffused additional information 14 by time-diffusing additional information 14. A multi-level signal generating part 113 generates a multi-level signal 16 the signal level of which varies substantially like a random number, based on information data 13, the random number sequence 12, and the diffused additional information 14. In a data receiving apparatus 201, a random number sequence generating part 211 generates a random number sequence 22 from key information 21. An information data decoding part 213 decodes information data 23 and additional information 24 based on the random number sequence 22.

### BACKGROUND OF THE INVENTION

1. Field of the Invention

The present invention relates to an apparatus that performs secret communication to prevent illegal wiretapping and interception by third parties. More particularly, the present invention relates to a data transmitting and a data receiving apparatuses that select and set a specific encoding/decoding (modulating/demodulating) method to perform data communication between authorized transmitters and receivers.

2. Description of the Background Art

Conventionally, to perform communication only among specific persons, a structure is generally adopted in which the original information (key information) for encoding and decoding is shared between the transmitter and the receiver and an operation or an inverse operation of the information data (plain text) to be transmitted is mathematically performed based on the original information to thereby realize secret communication. On the contrary, in recent years, some encrypting methods have been proposed that positively use a physical phenomenon on the transmission path. One of them is a method called Y-00 protocol that performs cipher communication by use of quantum noise caused on the optical transmission line. Japanese Laid-Open Patent Publication No. 2005-57313 (hereinafter, abbreviated as Patent Document 1) discloses a conventional data communication apparatus using the Y-00 protocol.

FIG. 10 is a block diagram showing an example of the structure of the conventional communication apparatus 9 using the Y-00 protocol. In FIG. 10, the conventional data communication apparatus 9 includes a transmitting part 901 and a receiving part 902 connected together through an optical transmission path 910. The transmitting part 901 has a random number sequence generating part 911, a scrambling part 912, and a modulating part 913. The receiving part 902 has a demodulating part 915, a random number sequence generating part 914, and an information data decoding part 916. The transmitting part 901 and the receiving part 902 previously share pieces of key information 91 and 96 of the same contents.

In the transmitting part 901, the random number sequence generating part 911 generates a random number sequence 92 based on the key information 91. The scrambling part 912 generates, as scrambled information data 93, a signal having a level corresponding to a pattern combination of information data 90 and the random number sequence 92. Specifically, the scrambling part 912 generates the scrambled information data 93 which is an enhanced modulated signal, for example, by use of the signal format shown in FIG. 11. That is, the scrambling part 912 divides the random number sequence 92 into a number, 2M, of patterns, arranges these patterns into a number, M, of combinations of two patterns (hereinafter, these combinations will be referred to as bases), and assigns “0” of the information data 90 to one level of each base and “1” to the other level thereof. At this time, the scrambling part 912 equally assigns “0” and “1” to the bases so that the levels corresponding to “0” and “1” of the information data 90 are not biased. In the example of FIG. 11, “0” and “1” are alternately assigned with respect to the direction in which the level of the scrambled information data 93 increases.

In Patent Document 1, the random number sequence generating part 911 is described as a “transmission pseudo-random number generating part,” the scrambling part 912, as a “modulating method specifying part” and a “laser modulation driving part,” the modulating part 913, as a “laser diode,” the demodulating part 915, as a “photodetector,” the random number sequence generating part 914, as a “reception pseudo-random number generating part,” and the information data decoding part 916, as a “determining circuit.”

FIG. 12 is a schematic view for explaining the signals configuration used in the conventional data communication apparatus 9. An example of signal configuration change when the number of patterns of the random number sequence is 4 (that is, M=4, pattern #0: “00,” pattern #1: “01,” pattern #2: “10,” and pattern #3: “11”) is shown in FIG. 12. For example, when the value of the information data 90 changes like “0111” (see FIG. 12(a)) and the pattern of the random number sequence 92 changes like “00,” “11,” “10,” and “01” (see FIG. 12(b)), the level of the scrambled information data 93 changes like “0361” as shown in FIG. 12(c). The modulating part 913 converts the scrambled information data 93 into a modulated signal 94 which is an optical intensity modulated signal, and transmits it through the optical transmission path 910.

In the receiving part 902, the demodulating part 915 photoelectrically converts the modulated signal 94 transmitted through the optical transmission path 910, and outputs it as scrambled information data 95. The random number sequence generating part 914 generates a random number sequence 97 the same as the random number sequence 92 of the transmitting part 901 based on the key information 96. The information data decoding part 916 determines which of the combinations of the levels of the scrambled information data shown in FIG. 11 is used, based on the pattern of the random number sequence 97, and decodes information data 98 based on the result of the determination.

Specifically, the information data decoding part 916 sets an identification level based on the pattern of the random number sequence 97 as shown in FIG. 12(e), and determines whether the level of the scrambled information data 95 is higher or lower than the identification level. In this example, the information data decoding part 916 determines that the level of the scrambled information data 95 is “low, low, high, and low” compared with the identification level. Then, the information data decoding part 916 determines that when the pattern # (number) of the random number sequence 97 is an even number, the low is “0” the high is “1” and when the pattern # (number) is an odd number, the low is “1” and the high is “0,” and outputs the determined value as the information data 98. In this example, since the pattern numbers of the random number sequence 97 are #0, #3, #2, and #1, that is, “an even number, an odd number, an even number, and an odd number,” the information data 98 is “0111.” Although the scrambled information data 95 includes noise, by appropriately setting the signal level, the error occurrence in the binary identification can be suppressed to a negligible level.

Next, wiretapping likely to be performed will be explained. Wiretappers try to decrypt the information data 90 or the key information 91 from the modulated signal 94 without possessing the key information shared between the transmitter and the receiver. When a wiretapper performs a binary identification similar to that performed by the authorized receiver, since he/she does not possess the key information, it is necessary for him/her to try the identification of the scrambled information data 95 for all the values that the key information can take. Such a method is not practical when the length of the key information is sufficiently long because the number of trials increases exponentially with respect to the length of the key information.

Therefore, as a more efficient method, it is considered that the wiretapper tries the decryption of the information data 90 or the key information 91 from the modulated signal 94 by use of wiretapping receiving part 903 as shown in FIG. 10. In the wiretapping receiving part 903, a demodulating part 921 demodulates a multi-level signal 81 from the modulated signal 94 obtained by the branching from the optical transmission path 910. A multi-level-identifying part 922 multi-level-identifies the multi-level signal 81, and outputs the information obtained by the identification, as a reception sequence 82. A decryption processing part 923 performs decryption processing on the reception sequence 82, thereby trying to identify the information data 90 or the key information 91. When such a decrypting method is used, if the multi-level signal 81 can be multi-level-identified without any error, the wiretapping receiving part 903 can decrypt the information data 90 or the key information 91 by one trial from the reception sequence 82 obtained by the identification.

However, when the modulated signal 94 is photoelectrically converted by the demodulating part 921, shot noise is caused and superimposed on the multi-level signal 81. It is known that this shot noise is always caused because of the principle of quantum mechanics. Here, by making the signal level interval of the multi-level signal 81 sufficiently shorter than the level of the shot noise, the possibility cannot be ignored that the multi-level signal 81 received by an identification error takes various multiple levels other than the correct signal level. Therefore, since it is necessary for the wiretapper to decrypt the reception sequence 82 in consideration of the possibility that the correct signal level of the multi-level signal 81 is a value other than the signal level obtained by the identification, the number of trials (the number of reception possibilities) required for the decryption processing is large, that is, the calculation amount is increased compared with when there is no identification error, so that safety from wiretapping is improved.

However, since the level of the shot noise caused in the demodulating part 921 is limited, the number of trials required for the decryption processing of the reception sequence 82 is limited to a certain extent. Thus, the conventional data communication apparatus 9 has a problem that the risk cannot be fundamentally dissolved that the wiretapper succeeds in decrypting the reception sequence 82 and identifies the information data 90 or the key information 91.

### SUMMARY OF THE INVENTION

Therefore, an object of the present invention is to solve the problem mentioned above, and to provide a data transmitting apparatus and a data receiving apparatus for safely transmitting additional information (new key information or the like) together with information data with the aim of ensuring safety by key update.

The present invention is directed to a data transmitting apparatus that encrypts information data by use of predetermined key information, and performs secret communication with a receiving apparatus. To attain the object mentioned above, the data transmitting apparatus according to the present invention is provided with: a random number sequence generating part that generates a random number sequence based on the predetermined key information; a diffusing part that generates diffused additional information by time-diffusing predetermined additional information based on the random number sequence; and a multi-level signal modulating part that generates a signal, a signal level of which varies substantially like a random number, based on the information data, the random number sequence, and the diffused additional information, performs predetermined modulation processing on the generated signal, and outputs the processed signal as a modulated signal.

The multi-level signal modulating part includes: a multi-level signal generating part that generates a multi-level signal, a signal level of which varies substantially like a random number, based on the information data, the random number sequence, and the diffused additional information; and a modulating part that performs the predetermined modulation processing on the multi-level signal, and outputs the modulated signal.

Preferably, the multi-level signal generating part has: a scrambling part that generates scrambled information data a signal level of which is multi-level-scrambled, based on the information data and the random number sequence; and an additional information superimposing part that generates the multi-level signal by superimposing the diffused additional information on the scrambled information data.

Moreover, the multi-level signal generating part generates the multi-level signal by converting a value obtained by digitally adding the information data, the random number sequence, and the diffused additional information by a predetermined method, into an analog value.

Preferably, the predetermined key information includes at least first key information and second key information. In such a case, the random number sequence generating part includes: a first random number sequence generating part that generates a first random number sequence based on the first key information; and a second random number sequence generating part that generates a second random number sequence based on the second key information. The diffusing part generates the diffused additional information by time-diffusing the additional information based on the second random number sequence. The multi-level signal generating part generates the multi-level signal based on the information data, the first random number sequence, and the diffused additional information.

The multi-level signal modulating part includes: a scrambling part that generates scrambled information data a signal level of which is multi-level-scrambled, based on the information data and the random number sequence; a first modulating part that generates a first modulated signal by performing predetermined modulation processing on the scrambled information data; a second modulating part that generates a second modulated signal by performing predetermined modulation processing on the diffused additional information; and an adding part that adds the first modulated signal and the second modulated signal, and outputs a signal resulting from the addition, as the modulated signal.

Preferably, the predetermined key information includes at least first key information and second key information. In such a case, the random number sequence generating part includes: a first random number sequence generating part that generates a first random number sequence based on the first key information; and a second random number sequence generating part that generates a second random number sequence based on the second key information. The scrambling part generates scrambled information data a signal level of which is multi-level-scrambled, based on the information data and the first random number sequence. The diffusing part generates the diffused additional information by time-diffusing the additional information based on the second random number sequence.

Preferably, a signal power of the diffused additional information is lower than a noise power included in a signal band corresponding to a chip rate of the diffused additional information. Moreover, a signal level of the diffused additional information is adjusted so that a signal level of the multi-level signal is any of signal levels that the scrambled information data can take. Moreover, a signal level of the diffused additional information is an integral multiple of a distance between adjoining signal points of the scrambled information data.

Preferably, a chip rate of the diffused additional information is an integral multiple of a symbol rate of the multi-level signal. Moreover, a chip rate of the diffused additional information may be an integral multiple of a symbol rate of the scrambled information data.

Preferably, the random number sequence inputted to the diffusing part is used for the time diffusion of the additional information after a predetermined section of the random number sequence is substantially periodically thinned.

Moreover, the present invention is also directed to a data receiving apparatus that receives information data encrypted by use of predetermined key information, and performs secret communication with a transmitting apparatus. To attain the object mentioned above, the data receiving apparatus according to the present invention is provided with: a random number sequence generating part that generates a random number sequence based on the predetermined key information; a demodulating part that performs predetermined demodulation processing on a modulated signal received from the transmitting apparatus, and outputs a multi-level signal a signal level of which varies substantially like a random number; a separating part that separates the multi-level signal into two paths; an information data decoding part that decodes the information data from the multi-level signal separated into one of the paths, based on the random number sequence; a scrambling part that generates scrambled information data a signal level of which is multi-level-scrambled, based on the information data and the random number sequence; a scrambled information data removing part that removes the scrambled information data from the multi-level signal separated into the other of the paths to thereby output diffused additional information obtained by time-diffusing predetermined additional information based on the random number sequence; and an inversely diffusing part that decodes the additional information by performing inverse diffusion processing on the diffused additional information by use of the random number sequence.

Preferably, the predetermined key information includes at least first key information and second key information. In such a case, the random number sequence generating part includes: a first random number sequence generating part that generates a first random number sequence based on the first key information; and a second random number sequence generating part that generates a second random number sequence based on the second key information. The information data decoding part decodes the information data from the multi-level signal separated into one of the paths, based on the first random number sequence. The scrambling part generates the scrambled information data the signal level of which is multi-level-scrambled, based on the information data and the first random number sequence. The scrambled information data removing part removes the scrambled information data from the multi-level signal separated into the other of the paths to thereby output diffused additional information obtained by time-diffusing predetermined additional information based on the second random number sequence. The inversely diffusing part decodes the additional information by performing inverse diffusion on the diffused additional information by use of the second random number sequence.

Preferably, a signal power of the diffused additional information is lower than a noise power included in a signal band corresponding to a chip rate of the diffused additional information. Moreover, a signal level of the diffused additional information is adjusted so that a signal level of the multi-level signal is any of signal levels that the scrambled information data can take. Moreover, a signal level of the diffused additional information is an integral multiple of a distance between adjoining signal points of the scrambled information data.

Preferably, a chip rate of the diffused additional information is an integral multiple of a symbol rate of the multi-level signal. Moreover, a chip rate of the diffused additional information is an integral multiple of a symbol rate of the scrambled information data.

Preferably, the random number sequence inputted to the inversely diffusing part is used for the time diffusion of the additional information after a predetermined section of the random number sequence is substantially periodically thinned.

Moreover, the processings performed by the random number sequence generating part, the diffusing part, and the multi-level signal modulating part that the data transmitting apparatus is provided with may also be regarded as a data transmitting method that provides a series of procedures. That is, it is a data transmitting method provided with: a random number sequence generating step of generating a random number sequence based on the predetermined key information; a diffusing step of generating diffused additional information by time-diffusing predetermined additional information based on the random number sequence; and a multi-level signal modulating step of generating a signal, a signal level of which varies substantially like a random number, based on the information data, the random number sequence, and the diffused additional information, performing predetermined modulation processing on the generated signal, and outputting the processed signal as a modulated signal.

Moreover, the processings performed by the random number sequence generating part, the demodulating part, the separating part, and the information data decoding part that the data receiving apparatus is provided with may also be regarded as a data receiving method that provides a series of procedures. That is, it is a data receiving method provided with: a random number sequence generating step of generating a random number sequence based on the predetermined key information; a demodulating step of performing predetermined demodulation processing on a modulated signal received from the transmitting apparatus, and outputting a multi-level signal a signal level of which varies substantially like a random number; a separating part of separating the multi-level signal into two paths; an information data decoding step of decoding the information data from the multi-level signal separated into one of the paths, based on the random number sequence; a step of generating scrambled information data a signal level of which is multi-level-scrambled, based on the information data and the random number sequence; a scrambled information data removing step of removing the scrambled information data from the multi-level signal separated into the other of the paths to thereby output diffused additional information obtained by time-diffusing predetermined additional information based on the random number sequence; and an inversely diffusing step of decoding the additional information by performing inverse diffusion processing on the diffused additional information by use of the random number sequence.

As described above, with the data transmitting apparatus and the data receiving apparatus according to the present invention, the stealthiness of communications can be enhanced by generating the multi-level signal by superimposing the time-diffused additional information on the scrambled information data. Since the additional information is transmitted together with the information data while communication stealthiness is ensured, the key information for update can be transmitted by the additional information. Consequently, the data transmitting apparatus and the data receiving apparatus can periodically update the key information, so that the resistance to decryption can be further improved.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an example of the structure of a communication apparatus 1 according to a first embodiment of the present invention;

FIG. 2 is a block diagram showing an example of the detailed structure of a data transmitting apparatus 101 according to the first embodiment of the present invention;

FIG. 3 is a schematic view showing an example of the signals generated in each part of the data transmitting apparatus 101 according to the first embodiment of the present invention;

FIG. 4 is a schematic view showing an example of the signals generated in each part of a data receiving apparatus 201 according to the first embodiment of the present invention;

FIG. 5 is a block diagram showing an example of the structure of a data transmitting apparatus 102 according to a second embodiment of the present invention;

FIG. 6 is a block diagram showing an example of the detailed structure of the data transmitting apparatus 102 according to the second embodiment of the present invention;

FIG. 7 is a block diagram showing an example of the structure of a data receiving apparatus 202 according to the second embodiment of the present invention;

FIG. 8 is a block diagram showing an example of the structure of a data transmitting apparatus 103 according to a third embodiment of the present invention;

FIG. 9 is a block diagram showing an example of the structure of a data transmitting apparatus 103a according to the third embodiment of the present invention;

FIG. 10 is a block diagram showing an example of the structure of the conventional data communication apparatus 9 using the Y-00 protocol;

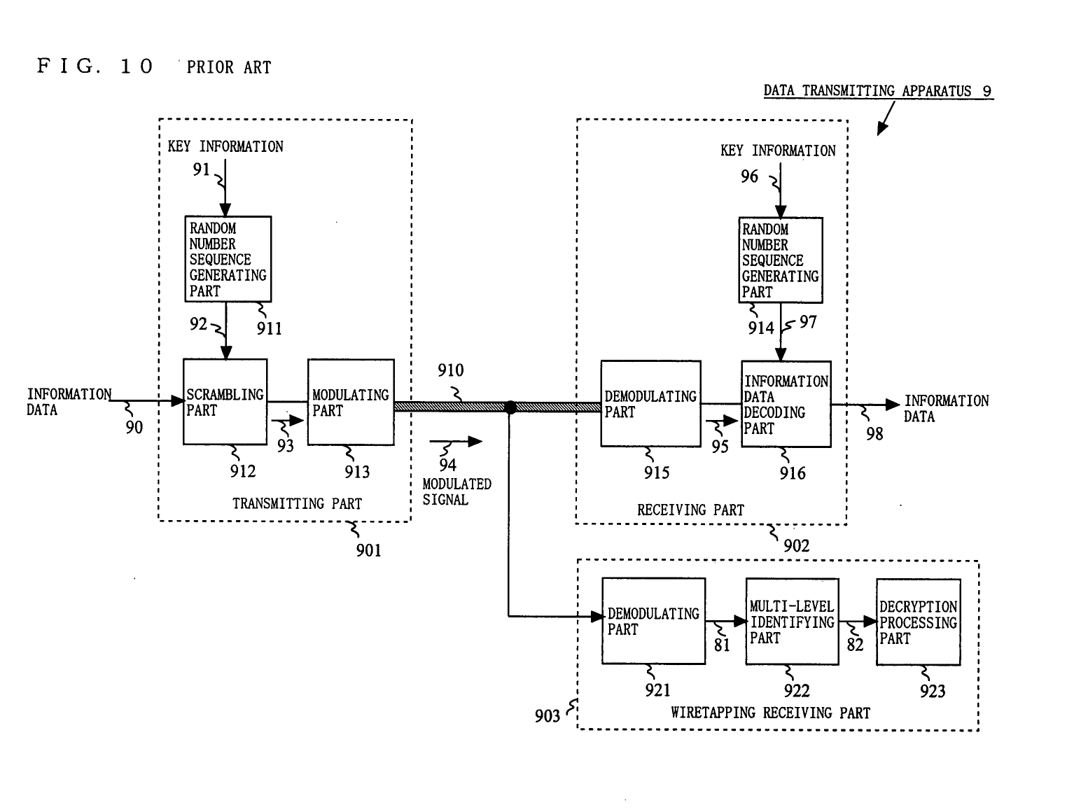

FIG. 11 is a view showing the signal format used in the Y-00 protocol; and

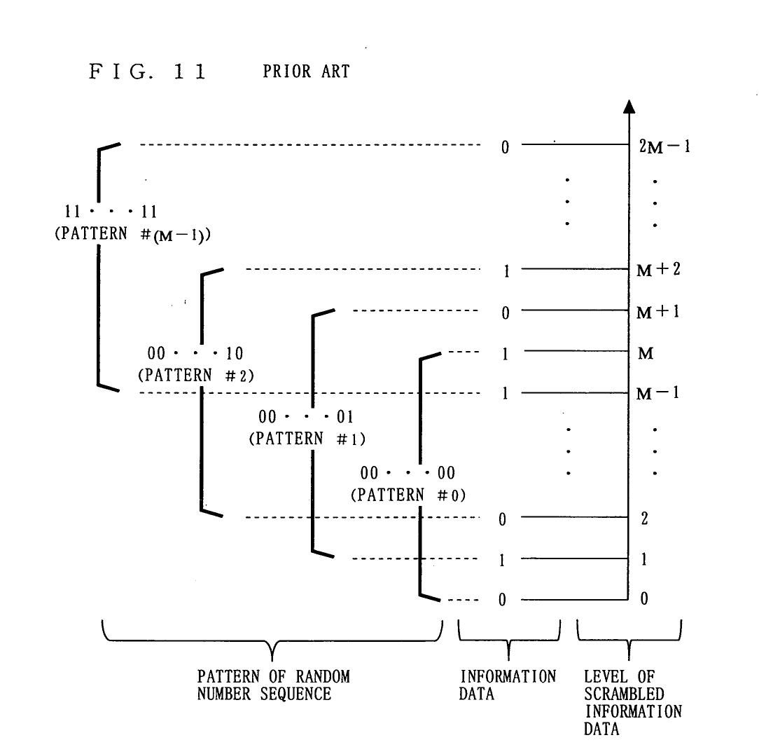

FIG. 12 is a schematic view for explaining the signals configuration used in the conventional data communication apparatus 9.

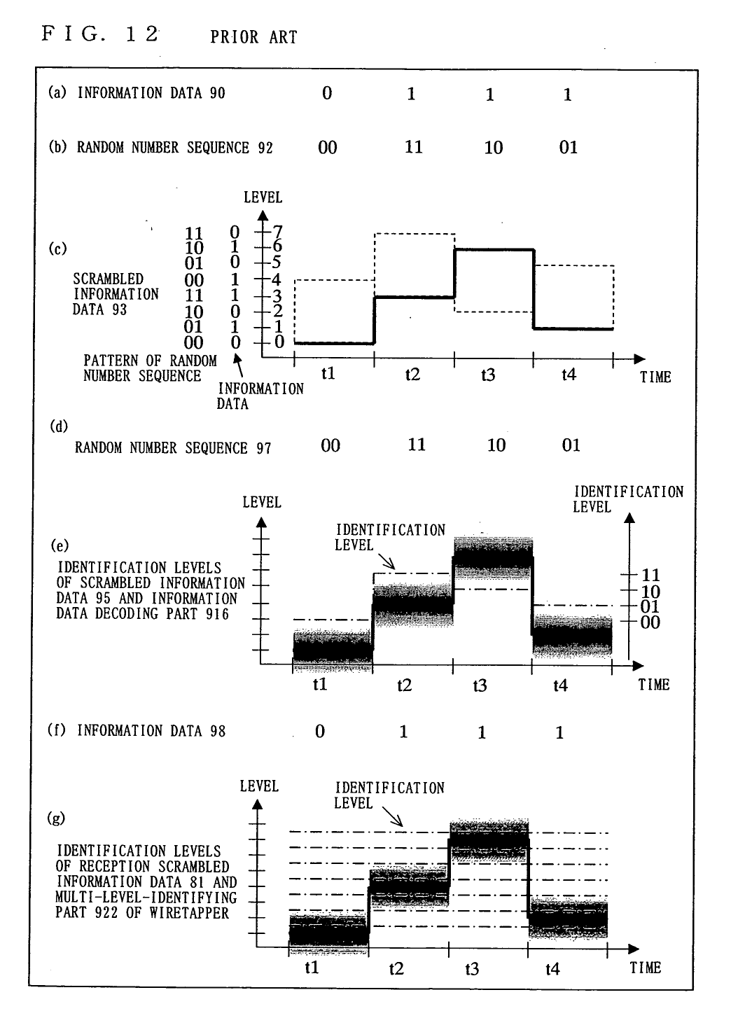

### DESCRIPTION OF THE PREFERRED EMBODIMENTS

Hereinafter, embodiments of the present invention will be explained with reference to the drawings.

### First Embodiment

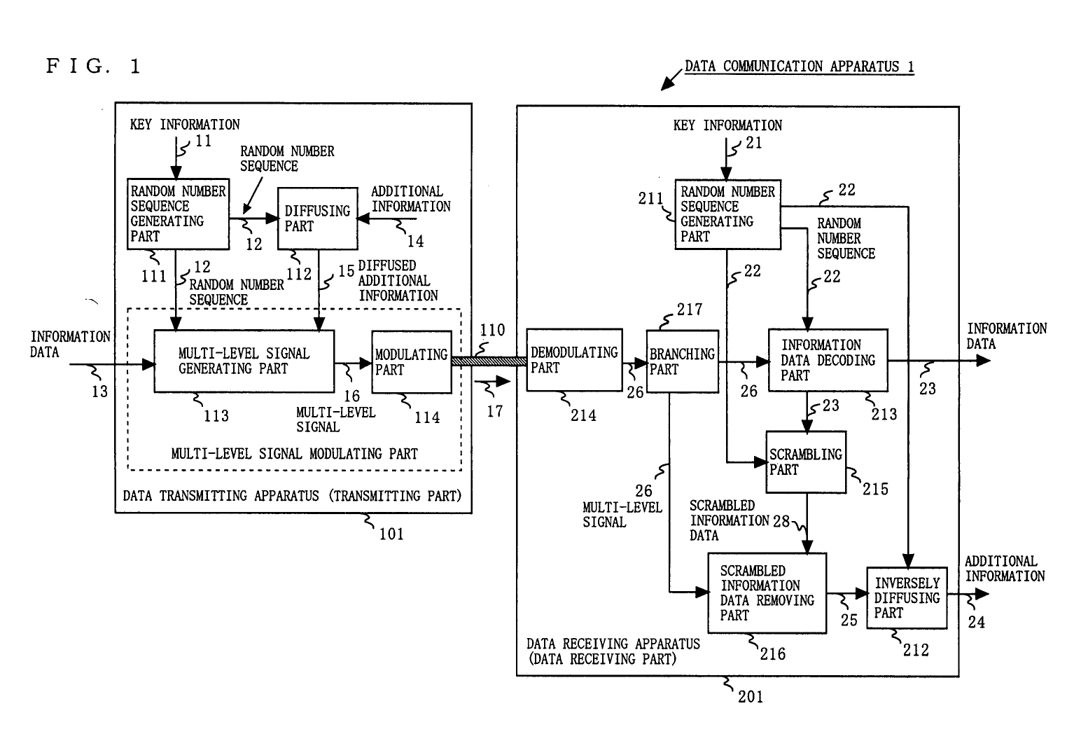

FIG. 1 is a block diagram showing an example of the structure of a communication apparatus 1 according to a first embodiment of the present invention. In FIG. 1, the data communication apparatus 1 includes a data transmitting apparatus 101 and a data receiving apparatus 201 connected together through a transmission path 110. The data transmitting apparatus 101 and the data receiving apparatus 201 previously share pieces of key information 11 and 21 of the same contents. As the transmission path 110, a metal line such as a LAN cable or a coaxial cable, or an optical waveguide such as an optical fiber cable is used. The transmission path 110 is not limited to a wired cable such as a LAN cable, and may be a free space that allows radio signals to propagate therethrough.

First, the data transmitting apparatus 101 will be explained. The data transmitting apparatus 101 has a random number sequence generating part 111, a diffusing part 112, a multi-level signal generating part 113, and a modulating part 114. The random number sequence generating part 111 generates a random number sequence 12 based on predetermined key information 11. The diffusing part 112 generates diffused additional information 15 by time-diffusing additional information 14 by use of the random number sequence 12. As the additional information 14, for example, the pieces of key information 11 and 21 for update are used. In such a case, since the data communication apparatus 1 can update the pieces of key information 11 and 21 by use of the additional information 14, a safer data communication can be realized. As the additional information 14, not only the pieces of key information 11 and 12 for update but any information may be used.

The multi-level signal generating part 113 generates a multi-level signal 16 that varies substantially like a random number, based on information data 13, the random number sequence 12 and the diffused additional information 15. The modulating part 114 generates a modulated signal 17 by performing predetermined modulation processing on the multi-level signal 16, and transmits the generated modulated signal 17 through the transmission path 110. Since the multi-level signal generating part 113 and the modulating part 114 are structures for generating the multi-level signal 16 and modulating the generated multi-level signal 16, they may be collectively referred to as a multi-level signal modulating part.

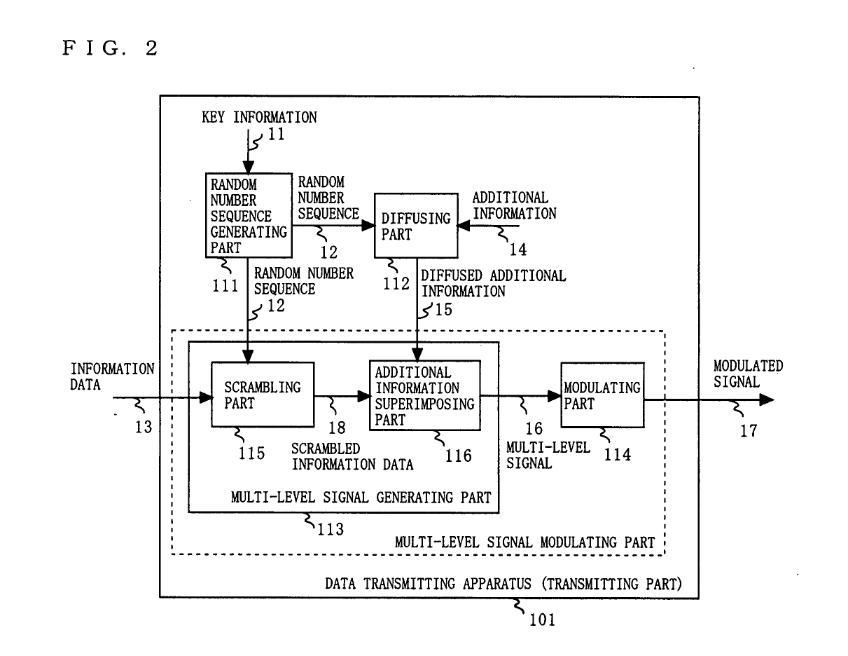

FIG. 2 is a block diagram showing an example of the detailed structure of the data transmitting apparatus 101 according to the first embodiment of the present invention. In FIG. 2, the structure other than the multi-level signal generating part 113 is similar to that of FIG. 1. The multi-level signal generating part 113 includes a scrambling part 115 and an additional information superimposing part 116. The scrambling part 115 generates scrambled information data 18 the signal level of which is multi-level-scrambled, based on the information data 13 and the random number sequence 12. The additional information superimposing part 116 generates the multi-level signal 16 by superimposing the diffused additional information 15 on the scrambled information data 18.

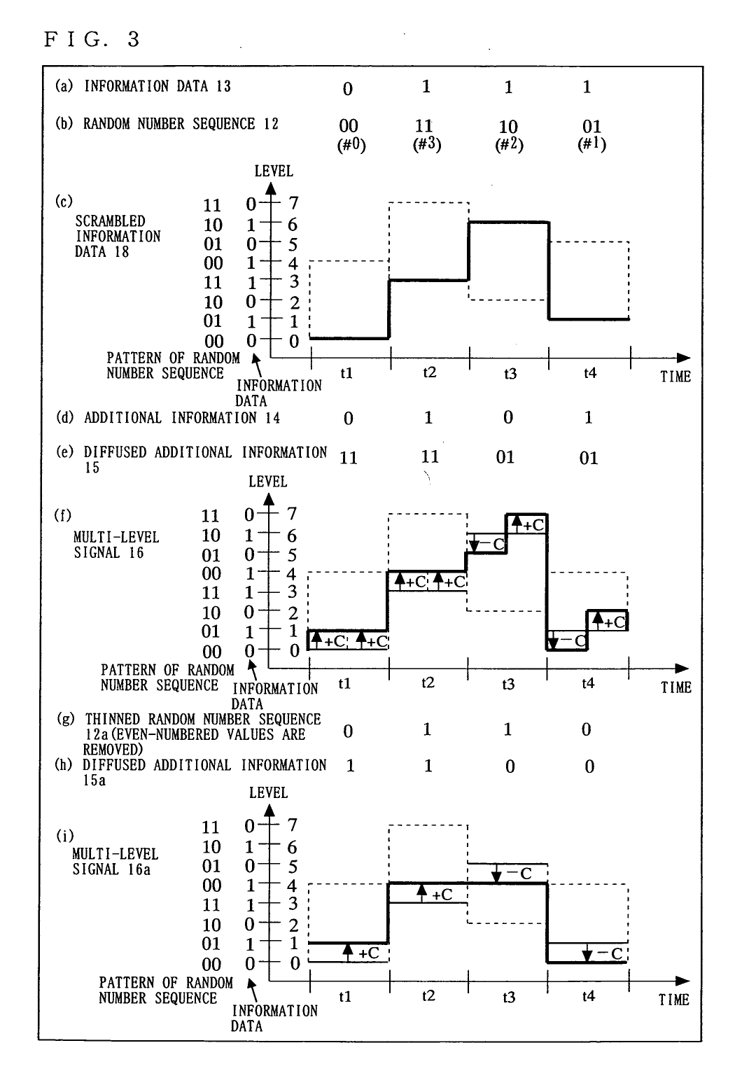

Subsequently, a concrete operation of the multi-level signal generating part 113 will be explained by use of FIG. 3. FIG. 3 is a schematic view showing an example of the signals generated in each part of the data transmitting apparatus 101 according to the first embodiment of the present invention. Referring to FIG. 3, for example, when the value of the information data 13 is A (A is 0 or 1) and the number of patterns of the random number sequence 12 is 4 (that is, M=4), the scrambling part 115 generates the scrambled information data 18 having a level of “AM+B” when the pattern number B of the random number sequence 12 is an even number and having a level of “(1−A)M+B” when B is an odd number. As a concrete example, when the information data 13 is “0111” (FIG. 3(a), the pattern number of the random number sequence 12 is 4, and the random number sequence 12 is “00: pattern #0,” “11: pattern #3,” “10: pattern #2,” and “01: pattern #1” (FIG. 3(b)), the level of the scrambled information data 18 is “0361” (FIG. 3(c)).

The diffusing part 112 generates the diffused additional information 15 by time-diffusing the additional information 14 by use of the random number sequence 12. For example, when the additional information 14 is “0101” (FIG. 3(d)) and the random number sequence 12 is “00111001,” the diffused additional information 15 is “11110101” (FIG. 3(e)). The additional information superimposing part 116 generates the multi-level signal 16 by superimposing the diffused additional information 15 on the scrambled information data 18. For example, the additional information superimposing part 116 generates the multi-level signal 16 by adding a signal with an amplitude level of −C, +C to the scrambled information data 18 according to the 0, 1 value of the diffused additional information 15 (FIG. 3(f)). It is desirable that the magnitude of the amplitude level C (that is, the signal power of the diffused additional information 15) be set so as to be smaller than the noise power included in a signal band corresponding to the chip rate of the diffused additional information 15. Lastly, the modulating part 114 generates the modulated signal 17 by performing the predetermined modulation processing on the multi-level signal 16. While examples of the modulated signal 17 include an optical polarization modulated signal, an optical intensity modulated signal, an amplitude modulated signal, a frequency modulated signal, and a phase modulated signal, the modulated signal 17 is not limited thereto, and may be any kind of modulated signal as long as signal transmission is possible.

It is desirable that the amplitude level C of the diffused additional information 15 superimposed on the scrambled information data 18 be adjusted so that the level of the multi-level signal 16 is any of the signal levels that the scrambled information data 18 can take. Thereby, the signal obtained by superimposing the diffused additional information 15 on the scrambled information data 18 (that is, the multi-level signal 16) overlaps the level of the scrambled information data 18 in another section, so that the occurrence of a signal level of the multi-level signal 16 depending only on the diffused additional information 15 can be prevented. Consequently, when a wiretapper decrypts the multi-level signal 16, the presence of the diffused additional information 15 is difficult to detect, so that the decryption of the multi-level signal 16 is difficult. This effect is obtained also by setting the amplitude level C of the diffused additional information 15 to an integral multiple of the distance between adjoining signal points of the scrambled information data 18 when the signal levels of the scrambled information data 18 are spaced uniformly.

Further, it is desirable that the chip rate of the diffused additional information 15 be an integral multiple of the symbol rate of the multi-level signal 16 or the scrambled information data 18. For example, the chip rate of the diffused additional information 15 can be made an integral multiple of the symbol rate of the multi-level signal 16 by the diffusing part 112 using the random number sequence 12 a predetermined section of which is substantially periodically thinned, for the time diffusion of the additional information 14. As a concrete example, the diffusing part 112 time-diffuses the additional information 14 “0101” by a thinned random number sequence 12a “0110” (FIG. 3(g)) obtained by removing the even-numbered values from the random number sequence 12 “00111001” (in this example, performs an exclusive OR operation of the thinned random number sequence 12a and the additional information 14), thereby generating diffused additional information 15a “1100” (FIG. 3(h)). Thereby, the multi-level signal 16a (FIG. 3(i)) becomes a signal in which the occurrence of level variations due to the diffused additional information 15a is suppressed in each symbol section. Consequently, when a wiretapper decrypts the multi-level signal 16a, the presence of the diffused additional information 15a is difficult to detect, so that decryption is more difficult.

When the inputted random number sequence 12, information data 13, and diffused additional information 15 are all digital signals, the multi-level signal generating part 113 may generate the multi-level signal 16 by calculating the level of the multi-level signal 16 in a manner as described above by performing digital processing (operation) on these signals, and converting the result into an analog value by use of a DA converter or the like. That is, the multi-level signal generating part 113 may generate the multi-level signal 16 by digitally adding the information data 13, the random number sequence 12, and the diffused additional information 15 by a predetermined method and converting the signal resulting from the digital addition into an analog value.

Next, the data receiving apparatus 201 will be explained. In FIG. 1, the data receiving apparatus 201 has a demodulating part 214, a branching part 217, a random number sequence generating part 211, an information data decoding part 213, a scrambling part 215, a scrambled information data removing part 216, and an inversely diffusing part 212. The demodulating part 214 performs predetermined demodulation processing on the modulated signal 17, and outputs a multi-level signal 26. The branching part 217 causes the multi-level signal 26 to branch to the information data decoding part 213 and to the scrambled information data removing part 216. The random number sequence generating part 211 generates a random number sequence 22 based on the key information 21. The information data decoding part 213 decodes information data 23 from the multi-level signal 26 based on the random number sequence 22. The scrambling part 215 generates scrambled information data 28 based on the random number sequence 22 and the information data 23. The scrambled information data removing part 216 removes the scrambled information data 28 from the multi-level signal 26 to thereby output diffused additional information 25. The diffused additional information 25 is information generated by the additional information 14 similar to additional information 24 being time-diffused based on the random number sequence 12 similar to the random number sequence 22 on the transmitting side. The inversely diffusing part 212 decodes the additional information 24 by performing inverse diffusion processing on the diffused additional information 25 by use of the random number sequence 22.

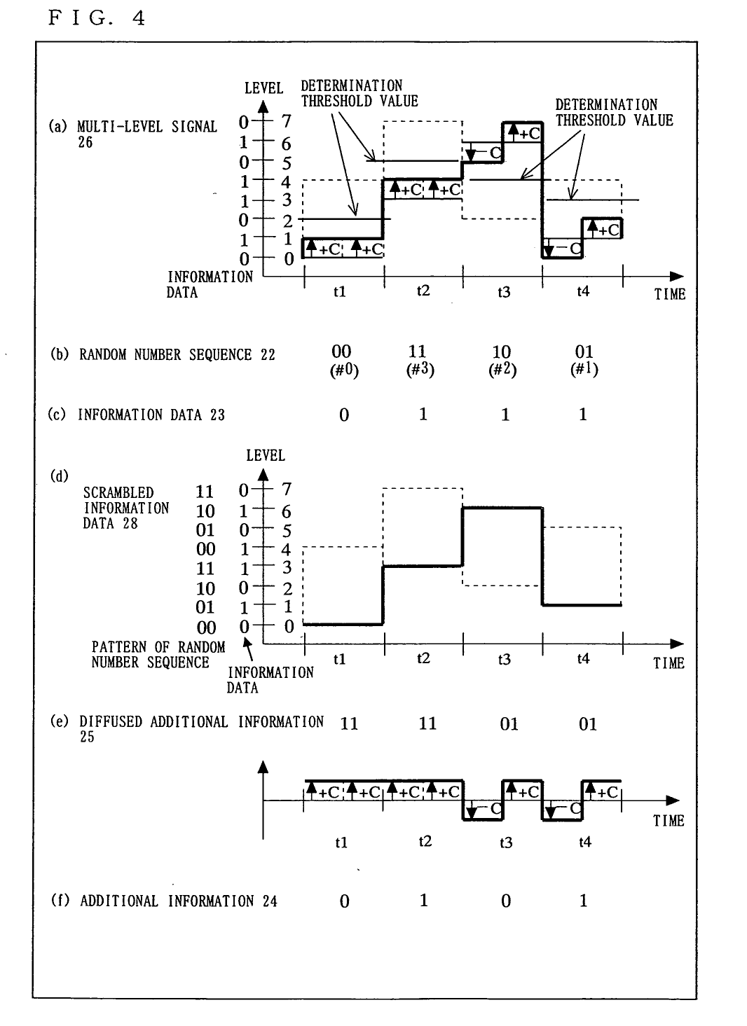

Subsequently, a concrete operation of the data receiving apparatus 201 will be explained by use of FIG. 4. FIG. 4 is a schematic view showing an example of the signals generated in each part of the data receiving apparatus 201 according to the first embodiment of the present invention. Referring to FIG. 4, the demodulating part 214 performs the demodulation processing corresponding to the modulating method in the data transmitting apparatus 101, on the modulated signal 17 to thereby output the multi-level signal 26 (FIG. 4(a)). The information data decoding part 213 performs a binary identification of the multi-level signal 26 using a determination threshold value with a level of “B+(M/2)” as the determination threshold value with respect to a pattern number B of the random number sequence 22. For example, when the random number sequence 22 is “00: pattern #0,” “11: pattern #3,” “10: pattern #2,” and “01: pattern #1” (FIG. 4(b)), the determination threshold value is “2543.” Thereby, the result of the identification of the multi-level signal 26 is “low, low, high, low.”

The information data decoding part 213 decodes the information data “0111” by assigning the high of the identification result to “0” and the low thereof to “1” when the pattern number B of the random number sequence 22 is an even number and assigning the high of the identification result to “1” and the low thereof to “0” when the pattern number B is an odd number (FIG. 4(c)). The scrambling part 215 generates the scrambled information data 28 from the random number sequence 22 and the information data 23 like the data transmitting apparatus 101 (FIG. 4(d)). The scrambled information data removing part 216 removes the level of the scrambled information data 28 from the multi-level signal 26, and outputs the diffused additional information 25 “11110101” (FIG. 4(e)). Lastly, the inversely diffusing part 212 decodes the additional information 24 “0101” by performing inverse diffusion processing on the diffused additional information 25 by use of the random number sequence 22 (FIG. 4(f)).

When the chip rate of the diffused additional information 15 is set to an integral multiple of the symbol rate of the multi-level signal 16 in the data transmitting apparatus 101, the inversely diffusing part 212 can decode the additional information 24 by performing inverse diffusion processing on diffused additional information 25 by use of the random number sequence 22 a predetermined section of which is substantially periodically thinned, like the data transmitting apparatus 101.

As described above, with the data transmitting apparatus 101 and the data receiving apparatus 201 according to the first embodiment of the present invention, the stealthiness of communications can be enhanced by generating the multi-level signal 16 by superimposing the time-diffused additional information 14 on the scrambled information data 18. Since the additional information 14 is transmitted together with the information data 13 while communication stealthiness is ensured, the pieces of key information 11 and 21 for update can be transmitted by the additional information 14. Consequently, the data transmitting apparatus 101 and the data receiving apparatus 201 can periodically update the pieces of key information 11 and 21, so that the resistance to decryption can be further improved.

While the transmission rates of the additional information 14 and the information data 13 are the same in the present embodiment, the present invention is not limited thereto; the transmission rate of the additional information 14 may be lower than that of the information data 13 so that the diffusivity is for obtaining sufficient signal quality by the diffusion/inverse diffusion processing.

### Second Embodiment

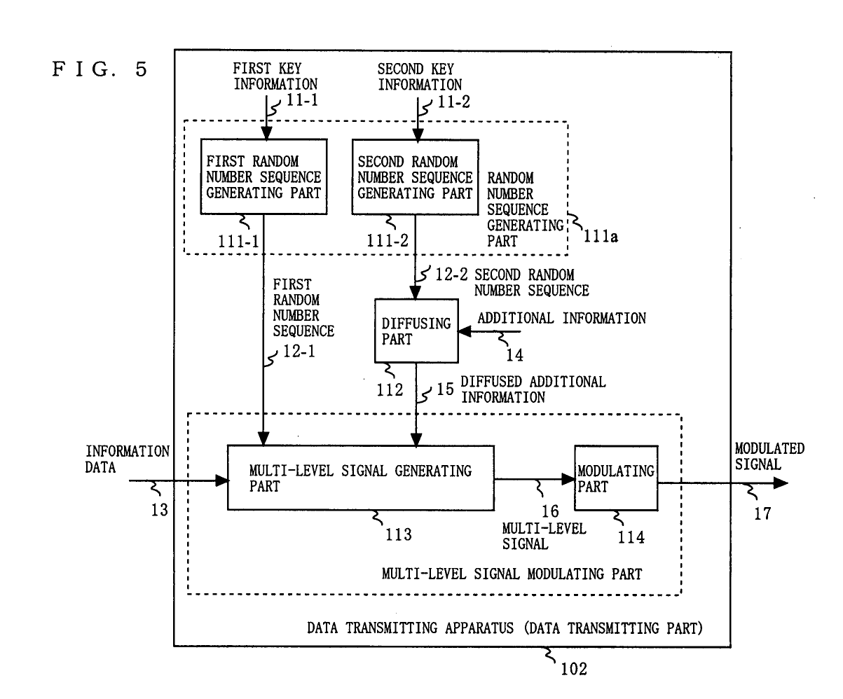

FIG. 5 is a block diagram showing an example of the structure of a data transmitting apparatus 102 according to a second embodiment of the present invention. In FIG. 5, the data transmitting apparatus 102 according to the second embodiment is different from that according to the first embodiment in the structure of a random number sequence generating part 111a. The random number sequence generating part 111a generates a first random number sequence 12-1 and a second random number sequence 12-2 by use of first key information 21-1 and second key information 21-2 different from each other.

Specifically, the random number sequence generating part 111a includes a first random number sequence generating part 111-1 and a second random number sequence generating part 111-2. The first random number sequence generating part 111-1 generates the first random number sequence 12-1 based on the first key information 11-1. The second random number sequence generating part 111-2 generates the second random number sequence 12-2 based on the second key information 11-2. The diffusing part 112 generates the diffused additional information 15 by time-diffusing the additional information 14 by use of the second random number sequence 12-2. The multi-level signal generating part 113 generates the multi-level signal 16 the signal level of which varies substantially like a random number, based on the information data 13, the first random number sequence 12-1, and the diffused additional information 15. The modulating part 114 generates the modulated signal 17 by performing predetermined modulation processing on the multi-level signal 16.

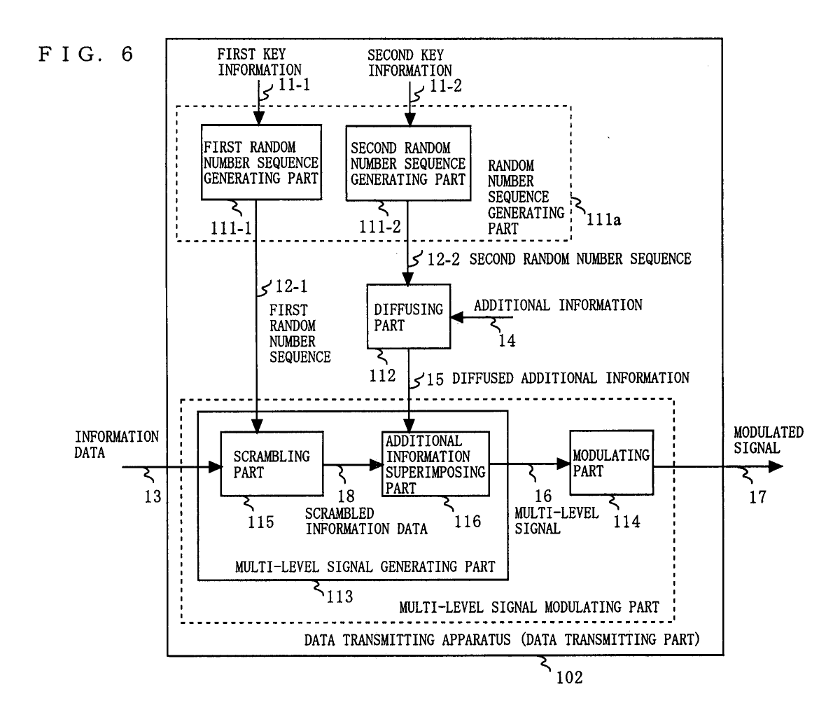

FIG. 6 is a block diagram showing an example of the detailed structure of the data transmitting apparatus 102 according to the second embodiment of the present invention. In FIG. 6, the structure other than the multi-level signal generating part 113 is similar to those of FIG. 5. The multi-level signal generating part 113 includes the scrambling part 115 and the additional information superimposing part 116. The scrambling part 115 generates the scrambled information data 18 the signal level of which is multi-level-scrambled, based on the information data 13 and the first random number sequence 12-1. The additional information superimposing part 116 generates the multi-level signal 16 by superimposing the diffused additional information 15 on the scrambled information data 18.

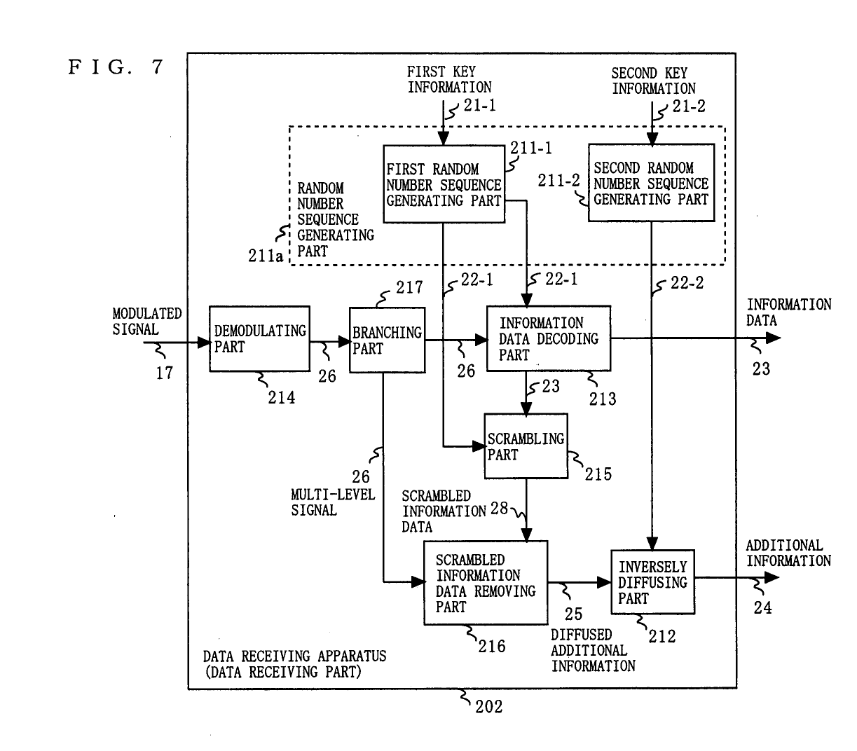

FIG. 7 is a block diagram showing an example of the structure of a data receiving apparatus 202 according to the second embodiment of the present invention. In FIG. 7, the data receiving apparatus 202 according to the second embodiment of the present invention is different from that of the first embodiment in the structure of a random number sequence generating part 211a. The random number sequence generating part 211a includes a first random number sequence generating part 211-1 and a second random number sequence generating part 211-2. The first random number sequence generating part 211-1 generates a first random number sequence 22-1 based on the first key information 21-1. The second random number sequence generating part 211-2 generates a second random number sequence 22-2 based on the second key information 21-2. The information data decoding part 213 decodes the information data 23 from the multi-level signal 26 based on the first random number sequence 22-1.

The scrambling part 215 generates the scrambled information data 28 the signal level of which is multi-level-scrambled, based on the information data 23 and the first random number sequence 22-1. The scrambled information data removing part 216 removes the scrambled information data 28 from the multi-level signal 26 to thereby output the diffused additional information 25. The diffused additional information 25 is information generated by the additional information 14 similar to the additional information 24 being time-diffused based on the random number sequence 12-2 similar to the second random number sequence 22-2 on the transmitting side. The inversely diffusing part 212 decodes the additional information 24 by performing inverse diffusion processing on the diffused additional information 25 by use of the second random number sequence 22-2. The structure other than this will not be described because it is similar to that of the data receiving apparatus 202 according to the first embodiment.

As described above, with the data transmitting apparatus 102 and the data receiving apparatus 202 according to the second embodiment of the present invention, a safer cipher communication can be realized by using different pieces of key information for the encryption of the information data 13 and for the encryption of the additional information 14.

### Third Embodiment

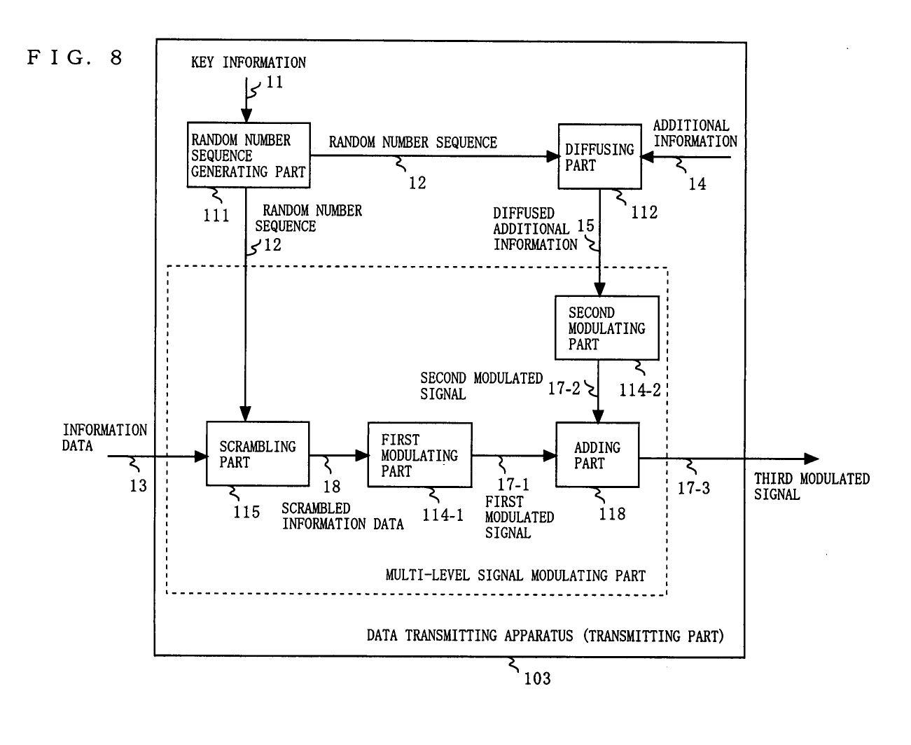

FIG. 8 is a block diagram showing an example of the structure of a data transmitting apparatus 103 according to a third embodiment of the present invention. In FIG. 8, the data transmitting apparatus 103 according to the third embodiment has the random number sequence generating part 111, the scrambling part 115, a first modulating part 114-1, the diffusing part 112, a second modulating part 114-2, and an adding part 118. The random number sequence generating part 111 generates the random number sequence 12 based on the predetermined key information 11. The scrambling part 115 generates the scrambled information data 18 the signal level of which is multi-level-scrambled, based on the information data 13 and the random number sequence 12. The first modulating part 114-1 generates a first modulated signal 17-1 by performing predetermined modulation processing on the scrambled information data 18. The diffusing part 112 generates the diffused additional information 15 by time-diffusing the additional information 14 by use of the random number sequence 12. The second modulating part 114-2 generates a second modulated signal 17-2 by performing predetermined modulation processing on the diffused additional information 15. The adding part 118 generates a third modulated signal 17-3 by adding the first modulated signal 17-1 and the second modulated signal 17-2. The scrambling part 115, the first modulating part 114-1, the second modulating part 114-2, and the adding part 118 may be collectively referred to as a multi-level signal modulating part.

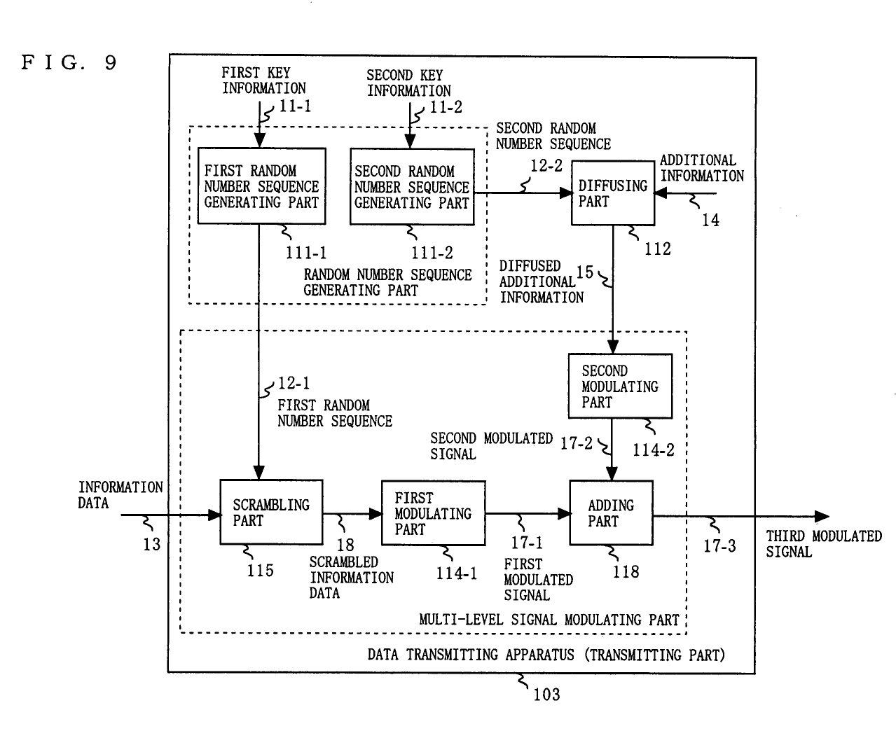

The data transmitting apparatus 103 according to the third embodiment of the present invention may have a different structure like that of a data transmitting apparatus 103a shown in FIG. 9. FIG. 9 is a block diagram showing an example of the structure of the data transmitting apparatus 103a according to the third embodiment of the present invention. In FIG. 9, the data transmitting apparatus 103a is different from the data transmitting apparatus 103 shown in FIG. 7 in the structure of a random number sequence generating part 111a. The random number sequence generating part 111a includes a first random number sequence generating part 111-1 and a second random number sequence generating part 111-2. The first random number sequence generating part 111-1 generates the first random number sequence 12-1 based on the first key information 11-1. The second random number sequence generating part 111-2 generates a second random number sequence 12-2 based on the second key information 11-2.

The scrambling part 115 generates the scrambled information data 18 the signal level of which is multi-level-scrambled, based on the information data 13 and the first random number sequence 12-1. The first modulating part 114-1 generates the first modulated signal 17-1 by performing predetermined modulation processing on the scrambled information data 18. The diffusing part 112 generates the diffused additional information 15 by time-diffusing the additional information 14 by use of the second random number sequence 12-2. The second modulating part 114-2 generates the second modulated signal 17-2 by performing predetermined modulation processing on the diffused additional information 15. The adding part 118 generates the third modulated signal 17-3 by adding the first modulated signal 17-1 and the second modulated signal 17-2.

As described above, with the data transmitting apparatus 103 according to the third embodiment of the present invention, similar effects as those of the first embodiment and the second embodiment can be obtained also by adding the scrambled information data 18 and the diffused additional information 15 after the optical intensity modulation.

The data communication apparatus according to the present invention is useful as a safe secret communication apparatus or the like that never suffers from wiretapping, interception or the like.

While the invention has been described in detail, the foregoing description is in all aspects illustrative and not restrictive. It is understood that numerous other modifications and variations can be devised without departing from the scope of the invention.

What is claimed is:

1. A data transmitting apparatus that encrypts information data by use of predetermined key information, and performs secret communication with a receiving apparatus, the data transmitting apparatus comprising:
a random number sequence generating part that generates a random number sequence based on the predetermined key information;
a diffusing part that generates diffused additional information by time-diffusing predetermined additional information based on the random number sequence; and
a multi-level signal modulating part that generates a signal, a signal level of which varies substantially like a random number, based on the information data, the random number sequence, and the diffused additional information, performs predetermined modulation processing on the generated signal, and outputs the processed signal as a modulated signal.

2. The data transmitting apparatus according to claim 1, wherein the multi-level signal modulating part includes:
a multi-level signal generating part that generates a multi-level signal, a signal level of which varies substantially like a random number, based on the information data, the random number sequence, and the diffused additional information; and
a modulating part that performs the predetermined modulation processing on the multi-level signal, and outputs the modulated signal.

3. The data transmitting apparatus according to claim 2, wherein the multi-level signal generating part has:
a scrambling part that generates scrambled information data a signal level of which is multi-level-scrambled, based on the information data and the random number sequence; and
an additional information superimposing part that generates the multi-level signal by superimposing the diffused additional information on the scrambled information data.

4. The data transmitting apparatus according to claim 2, wherein the multi-level signal generating part generates the multi-level signal by converting a value obtained by digitally adding the information data, the random number sequence, and the diffused additional information by a predetermined method, into an analog value.

5. The data transmitting apparatus according to claim 2, wherein the predetermined key information includes at least first key information and second key information,
the random number sequence generating part includes:
a first random number sequence generating part that generates a first random number sequence based on the first key information; and
a second random number sequence generating part that generates a second random number sequence based on the second key information,
the diffusing part generates the diffused additional information by time-diffusing the additional information based on the second random number sequence, and
the multi-level signal generating part generates the multi-level signal based on the information data, the first random number sequence, and the diffused additional information.

6. The data transmitting apparatus according to claim 1, wherein the multi-level signal modulating part includes:
a scrambling part that generates scrambled information data a signal level of which is multi-level-scrambled, based on the information data and the random number sequence;
a first modulating part that generates a first modulated signal by performing predetermined modulation processing on the scrambled information data;
a second modulating part that generates a second modulated signal by performing predetermined modulation processing on the diffused additional information; and
an adding part that adds the first modulated signal and the second modulated signal, and outputs a signal resulting from the addition, as the modulated signal.

7. The data transmitting apparatus according to claim 6, wherein the predetermined key information includes at least first key information and second key information,
the random number sequence generating part includes:
a first random number sequence generating part that generates a first random number sequence based on the first key information; and
a second random number sequence generating part that generates a second random number sequence based on the second key information,
the scrambling part generates scrambled information data a signal level of which is multi-level-scrambled, based on the information data and the first random number sequence, and
the diffusing part generates the diffused additional information by time-diffusing the additional information based on the second random number sequence.

8. The data transmitting apparatus according to claim 1, wherein a signal power of the diffused additional information is lower than a noise power included in a signal band corresponding to a chip rate of the diffused additional information.

9. The data transmitting apparatus according to claim 3, wherein a signal level of the diffused additional information is adjusted so that a signal level of the multi-level signal is any of signal levels that the scrambled information data can take.

10. The data transmitting apparatus according to claim 3, wherein a signal level of the diffused additional information is an integral multiple of a distance between adjoining signal points of the scrambled information data.

11. The data transmitting apparatus according to claim 2, wherein a chip rate of the diffused additional information is an integral multiple of a symbol rate of the multi-level signal.

12. The data transmitting apparatus according to claim 6, wherein a chip rate of the diffused additional information is an integral multiple of a symbol rate of the scrambled information data.

13. The data transmitting apparatus according to claim 1, wherein the random number sequence inputted to the diffusing part is used for the time diffusion of the additional information after a predetermined section of the random number sequence is substantially periodically thinned.

14. A data receiving apparatus that receives information data encrypted by use of predetermined key information, and performs secret communication with a transmitting apparatus, the data receiving apparatus comprising:
a random number sequence generating part that generates a random number sequence based on the predetermined key information;
a demodulating part that performs predetermined demodulation processing on a modulated signal received from the transmitting apparatus, and outputs a multi-level signal a signal level of which varies substantially like a random number;
a separating part that separates the multi-level signal into two paths;
an information data decoding part that decodes the information data from the multi-level signal separated into one of the paths, based on the random number sequence;
a scrambling part that generates scrambled information data a signal level of which is multi-level-scrambled, based on the information data and the random number sequence;
a scrambled information data removing part that removes the scrambled information data from the multi-level signal separated into the other of the paths to thereby output diffused additional information obtained by time-diffusing predetermined additional information based on the random number sequence; and
an inversely diffusing part that decodes the additional information by performing inverse diffusion processing on the diffused additional information by use of the random number sequence.

15. The data receiving apparatus according to claim 14, wherein the predetermined key information includes at least first key information and second key information,
the random number sequence generating part includes:
a first random number sequence generating part that generates a first random number sequence based on the first key information; and
a second random number sequence generating part that generates a second random number sequence based on the second key information,
the information data decoding part decodes the information data from the multi-level signal separated into one of the paths, based on the first random number sequence,
the scrambling part generates the scrambled information data the signal level of which is multi-level-scrambled, based on the information data and the first random number sequence,
the scrambled information data removing part removes the scrambled information data from the multi-level signal separated into the other of the paths to thereby output diffused additional information obtained by time-diffusing predetermined additional information based on the second random number sequence; and
the inversely diffusing part decodes the additional information by performing inverse diffusion on the diffused additional information by use of the second random number sequence.

16. The data receiving apparatus according to claim 14, wherein a signal power of the diffused additional information is lower than a noise power included in a signal band corresponding to a chip rate of the diffused additional information.

17. The data receiving apparatus according to claim 14, wherein a signal level of the diffused additional information is adjusted so that a signal level of the multi-level signal is any of signal levels that the scrambled information data can take.

18. The data receiving apparatus according to claim 14, wherein a signal level of the diffused additional information is an integral multiple of a distance between adjoining signal points of the scrambled information data.

19. The data receiving apparatus according to claim 14, wherein a chip rate of the diffused additional information is an integral multiple of a symbol rate of the multi-level signal.

20. The data receiving apparatus according to claim 14, wherein a chip rate of the diffused additional information is an integral multiple of a symbol rate of the scrambled information data.

21. The data receiving apparatus according to claim 14, wherein the random number sequence inputted to the inversely diffusing part is used for the inverse diffusion processing of the diffused additional information after a predetermined section of the random number sequence is substantially periodically thinned.

22. A data transmitting method in which a data transmitting apparatus encrypts information data by use of predetermined key information, and performs secret communication with a receiving apparatus, the data transmitting method comprising:
a random number sequence generating step of generating a random number sequence based on the predetermined key information;
a diffusing step of generating diffused additional information by time-diffusing predetermined additional information based on the random number sequence; and
a multi-level signal modulating step of generating a signal, a signal level of which varies substantially like a random number, based on the information data, the random number sequence, and the diffused additional information, performing predetermined modulation processing on the generated signal, and outputting the processed signal as a modulated signal.

23. A data receiving method in which a data receiving apparatus receives information data encrypted by use of predetermined key information, and performs secret communication with a transmitting apparatus, the data receiving method comprising:
a random number sequence generating step of generating a random number sequence based on the predetermined key information;
a demodulating step of performing predetermined demodulation processing on a modulated signal received from the transmitting apparatus, and outputting a multi-level signal a signal level of which varies substantially like a random number;
a separating part of separating the multi-level signal into two paths;
an information data decoding step of decoding the information data from the multi-level signal separated into one of the paths, based on the random number sequence;
a step of generating scrambled information data a signal level of which is multi-level-scrambled, based on the information data and the random number sequence;
a scrambled information data removing step of removing the scrambled information data from the multi-level signal separated into the other of the paths to thereby output diffused additional information obtained by time-diffusing predetermined additional information based on the random number sequence; and
an inversely diffusing step of decoding the additional information by performing inverse diffusion processing on the diffused additional information by use of the random number sequence.
